(19) United States
(12) Patent Application Publication
(10) Pub. No.: US 2025/0232012 A1
(43) Pub. Date: Jul. 17, 2025

(54) AUTHENTICATION APPARATUS, AUTHENTICATION METHOD, IMAGE CAPTURING APPARATUS, METHOD OF CONTROLLING THE SAME AND STORAGE MEDIUM

(71) Applicant: CANON KABUSHIKI KAISHA, Tokyo (JP)

(72) Inventor: SHOHEI KATSUYA, Kanagawa (JP)

(21) Appl. No.: 18/990,163

(22) Filed: Dec. 20, 2024

(30) Foreign Application Priority Data
Jan. 11, 2024 (JP) 2024-002790

(51) Int. Cl. G06F 21/31

(52) U.S. Cl. CPC G06F 21/31

(57) ABSTRACT

An authentication apparatus includes a detection unit configured to detect an object from an inputted image, a collation unit configured to collate the object detected by the detection unit with an authentication subject registered in advance, and to output a collation score indicating a similarity degree between the object and the authentication subject, an update unit configured, based on the collation score, to update an authentication score, which is an evaluation value that indicates a degree to which the object matches the authentication subject, and an authentication unit configured to authenticate the object based on the authentication score, wherein the update unit changes a method of updating the authentication score based on a magnitude relationship between the collation score and the authentication score.

### CROSS-REFERENCE TO PRIORITY APPLICATION

This application claims the benefit of Japanese Patent Application No. 2024-002790, filed Jan. 11, 2024, which is hereby incorporated by reference herein in its entirety.

### BACKGROUND OF THE INVENTION

### Field of the Invention

The present invention relates to an authentication apparatus for authenticating a person.

### Description of the Related Art

Conventionally, image capturing apparatus products, such as a digital cameras, having a tracking autofocus (AF) mode have been put into practical use. A tracking AF mode is a mode in which a face or a pupil of a person is detected from images continuously outputted from an image capturing element, and a focus state and an exposure state are continuously optimized for the detected face or pupil of the person. Further, a technique of registering people in advance and selecting a registered person using face authentication in order to select a desired tracking subject from among a plurality of objects is described in Japanese Patent Laid-Open No. 2008-187591.

In general, in face authentication registration processing, feature information is extracted from a face image and stored in a non-volatile memory. At the time of image capture, a face is detected in images continuously outputted from an image capturing element, and feature information of the detected face is extracted. A similarity degree between this feature information and feature information stored in a non-volatile memory is compared to determine whether or not the person is registered.

In recent years, the use of deep learning as an algorithm for face authentication has become common, and while performance has improved, processing load has also increased in parallel thereto. Especially in apparatuses using embedded software which have limited resources, such as a digital camera, it is difficult to perform high processing load authentication processing in real time with the limited resources.

Therefore, Japanese Patent No. 5963525 proposes, as a method of efficiently performing authentication processing with limited resources, a method in which collation processing is not performed after authentication has once succeeded for an object, and an authentication state is inherited by the use of tracking.

However, in the method for inheriting the authentication state by the use of tracking, cases where another object is erroneously tracked due to object crossing, crowding, or the like, are conceivable, and in such cases, an authentication state will end up being inherited by another person (“erroneous inheritance state”). For this reason, it is necessary to perform collation again, as necessary, even if an object has been successfully authenticated once, and to cancel the authentication state in the case of an “erroneous inheritance state”. Meanwhile, if a collation is performed again, the collation score may decrease depending on the state, even if the object should be kept in the authentication state, and there is a possibility of rejection of the actual person.

### SUMMARY OF THE INVENTION

The present invention has been made in view of the above-described problems, and aims to achieve both prevention of an authentication state of another person from being inherited erroneously and prevention of the actual person being rejected due to re-authentication when authenticating a person.

According to a first aspect of the present invention, there is provided an authentication apparatus, comprising: at least one processor or circuit and a memory storing instructions to cause the at least one processor or circuit to perform operations of the following units: a detection unit configured to detect an object from an inputted image; a collation unit configured to collate the object detected by the detection unit with an authentication subject registered in advance, and output a collation score indicating a similarity degree between the object and the authentication subject; an update unit configured to, based on the collation score, update an authentication score, which is an evaluation value that indicates a degree to which the object matches the authentication subject; and an authentication unit configured to authenticate the object based on the authentication score, wherein the update unit changes a method of updating the authentication score based on a magnitude relationship between the collation score and the authentication score.

According to a second aspect of the present invention, there is provided an authentication method comprising: detecting an object from an inputted image; collating the detected object with an authentication subject registered in advance, and outputting a collation score indicating a similarity degree between the object and the authentication subject; based on the collation score, updating an authentication score, which is an evaluation value that indicates a degree to which the object matches the authentication subject; and authenticating the object based on the authentication score, wherein in the updating, a method of updating the authentication score is changed based on a magnitude relationship between the collation score and the authentication score.

According to a third aspect of the present invention, there is provided an image capturing apparatus, comprising: at least one processor or circuit and a memory storing instructions to cause the at least one processor or circuit to perform operations of the following units: a detection unit configured to detect an object from a captured image; a collation unit configured to collate the object detected by the detection unit with an authentication subject registered in advance, and output a collation score indicating a similarity degree between the object and the authentication subject; an update unit configured to, based on the collation score, update an authentication score, which is an evaluation value that indicates a degree to which the object matches the authentication subject; and a determination unit configured to determine a main object based on the authentication score, wherein the update unit changes a method of updating the authentication score based on a magnitude relationship between the collation score and the authentication score.

According to a fourth aspect of the present invention, there is provided a method of controlling an image capturing apparatus, comprising: detecting an object from a captured image; collating the detected object with an authentication subject registered in advance, and outputting a collation score indicating a similarity degree between the object and the authentication subject; based on the collation score, updating an authentication score, which is an evaluation value that indicates a degree to which the object matches the authentication subject; and determining a main object based on the authentication score, wherein in the updating, a method of updating the authentication score is changed based on a magnitude relationship between the collation score and the authentication score.

Further features of the present invention will become apparent from the following description of exemplary embodiments with reference to the attached drawings.

### BRIEF DESCRIPTION OF THE DRAWINGS

FIG. 1 is a view illustrating a configuration of a digital single-lens camera, which is an embodiment of an image capturing apparatus of the present invention.

FIG. 2 is a block diagram of a control system of a camera.

FIG. 3 is a flowchart for describing control from when an image is acquired until when a main object is determined.

FIG. 4 is a flowchart for describing in detail collation processing.

FIG. 5 is a view illustrating a concrete example of a scene in which rejection of the actual person can be prevented.

FIG. 6 is a view illustrating a concrete example of a scene in which an authentication state of another person being inherited erroneously can be prevented.

### DESCRIPTION OF THE EMBODIMENTS

Hereafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

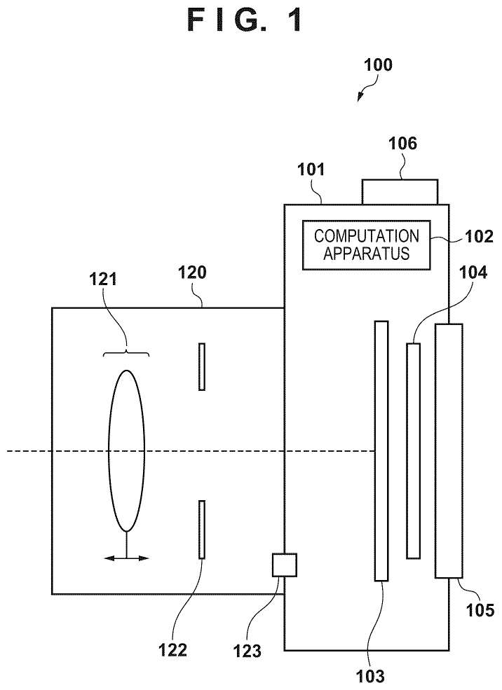

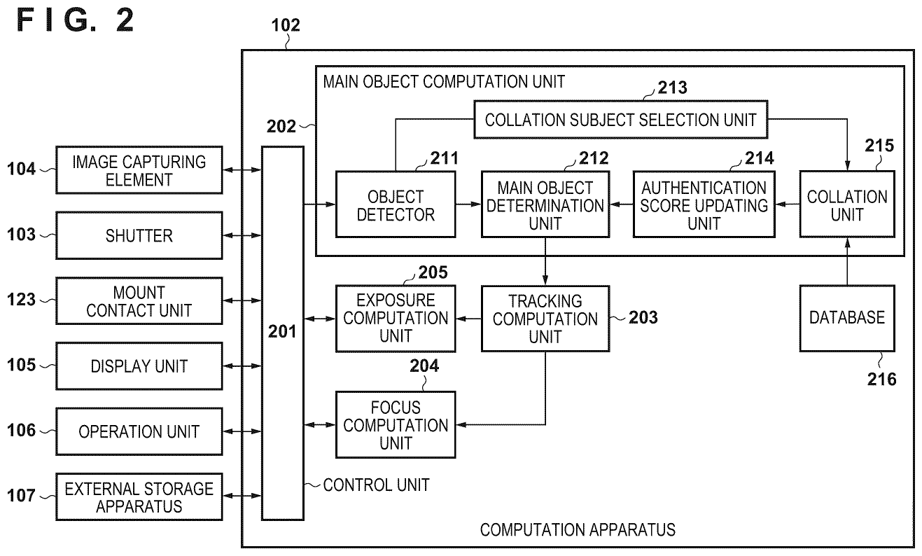

FIG. 1 is a view illustrating a configuration of a digital single-lens camera (hereinafter, also simply referred to as a camera) 100 which is an embodiment of an image capturing apparatus of the present invention. FIG. 2 is a view illustrating a configuration related to control of the digital single-lens camera 100.

In the camera 100 of the present embodiment, as illustrated in FIG. 1, a detachable interchangeable lens unit 120 is mounted on the front side (object side) of a camera body 101. The lens unit 120 includes a focus lens 121, a diaphragm 122, and the like, and is electrically connected to the camera body 101 via a mount contact portion 123. Through this electrical connection, a control unit 201 (refer to FIG. 2) of the camera body 101 can control the lens unit 120 to adjust the amount of light taken into the camera body 101 and the focus position. Note that the focus lens 121 can be manually adjusted by a user.

An image capturing element 104 that captures an object image is constituted by a CCD, a CMOS sensor, and the like, and includes an infrared cut filter, a low-pass filter, and the like. The image capturing element 104 photoelectrically converts an object image formed by light passing through the image capturing optical system of the lens unit 120 at the time of image capturing, and transmits signal information for generating a captured image to a computation apparatus 102. The computation apparatus 102 generates captured images from received signal information, stores the captured images in an external storage apparatus 107 (refer to FIG. 2), and displays the captured images on a display unit 105 such as an LCD. A shutter 103 shields the image capturing element 104 when not image capturing, and opens to expose the image capturing element 104 during image capturing.

Next, configurations related to the control of the camera 100 will be described with reference to FIG. 2.

The computation apparatus 102 includes a multi-core CPU, a RAM and a ROM capable of processing a plurality of tasks in parallel, dedicated circuitry for executing particular computation processing at high speed, and the like. The computation apparatus 102 includes the control unit 201, a main object computation unit 202 for detecting an object, a tracking computation unit 203, a focus computation unit 204, an exposure computation unit 205, and the like. The control unit 201 controls each unit of the camera body 101 and the lens unit 120.

The main object computation unit 202 includes an object detector 211 that detects an object, a main object determination unit 212 that performs authentication and main object determination, a collation subject selection unit 213 that selects a collation subject, an authentication score updating unit 214 that updates an authentication score, and a collation unit 215 that performs collation.

Continuous images acquired from the image capturing element 104 are sequentially inputted into the object detector 211, and processing for detecting one or a plurality of object regions in each image is performed. In the present embodiment, a target object is a face of a person. As the detection method, any known method such as AdaBoost or a method using a convolutional neural network can be used. Further, the detection method may be implemented as a program running on a CPU, as dedicated hardware, or as a combination thereof. The object detection result obtained from the object detector 211 is sent to the main object determination unit 212 and the collation subject selection unit 213.

The collation subject selection unit 213 selects a collation subject from among the detected objects. The number of objects to be collated at one time can be determined by the processing speed of the collation unit 215 and the frame rate of the continuous images, and one or a plurality of objects may be collated at one time. In addition, there may be a frame in which an object is detected but a collation subject is not selected. The selected collation subject is sent to the collation unit 215 after a face region is trimmed and scaled to a predetermined size.

Upon receiving the face region image, the collation unit 215 extracts feature information from the image, and compares the similarity degree with feature information of an object registered as an authentication subject in advance in a database 216 to perform collation processing. The collation result is used in authentication to determine which registered object the collation subject is or to determine whether a corresponding registered object exists. Upon completion of the series of collation processes, the collation results are sent to the authentication score updating unit 214.

A plurality of objects can be registered in the database 216, and the object information, the feature information, and the image of the object region are stored for each object. In addition, the user can set a priority order for each registered object, and the priority order is stored in respective object information.

The authentication score updating unit 214 updates the authentication state and the authentication score of each object using the received collation result. The main object determination unit 212 determines a main object based on the authentication state and the object detection result.

The tracking computation unit 203 computes an AF region and automatic exposure (AE) region in live view (LV) images (that is, in the image capturing element 104) so as to track the main object determined by the main object determination unit 212.

The focus computation unit 204 acquires focus information (a contrast evaluation value of an LV image and a defocus amount of the image capture optical system) in an AF region. The control unit 201 transmits a focus instruction for controlling the position of the focus lens 121 to the lens unit 120 based on the focus information. The lens unit 120 drives the focus lens 121 in response to the focus instruction. As a result, tracking AF is performed as focusing control for the main object.

The exposure computation unit 205 acquires luminance information in an AE region. The control unit 201 transmits a diaphragm instruction for controlling the opening amount of the diaphragm 122 to the lens unit 120 based on the luminance information. The lens unit 120 drives the diaphragm 122 in response to the diaphragm instruction. As a result, tracking AE is performed as exposure control for the main object.

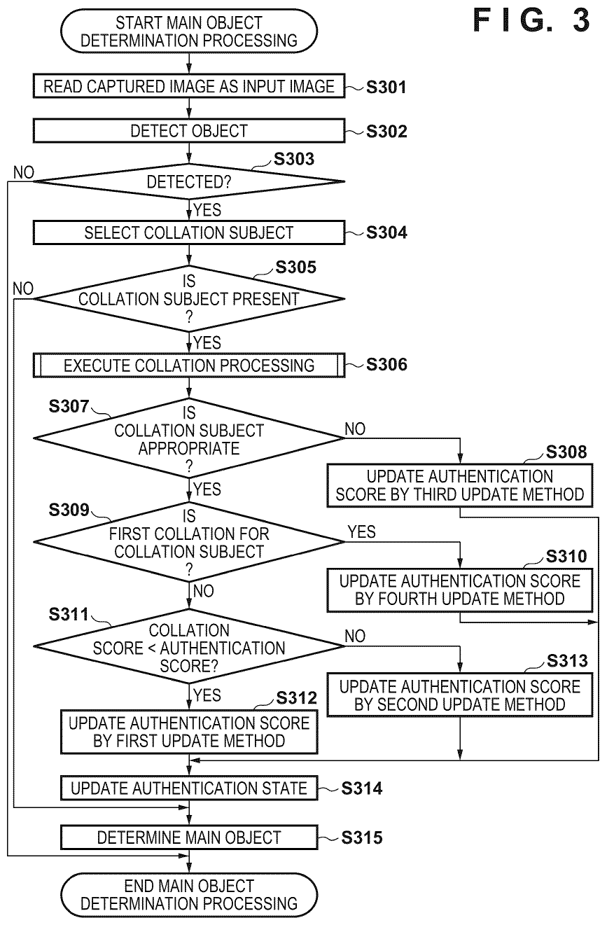

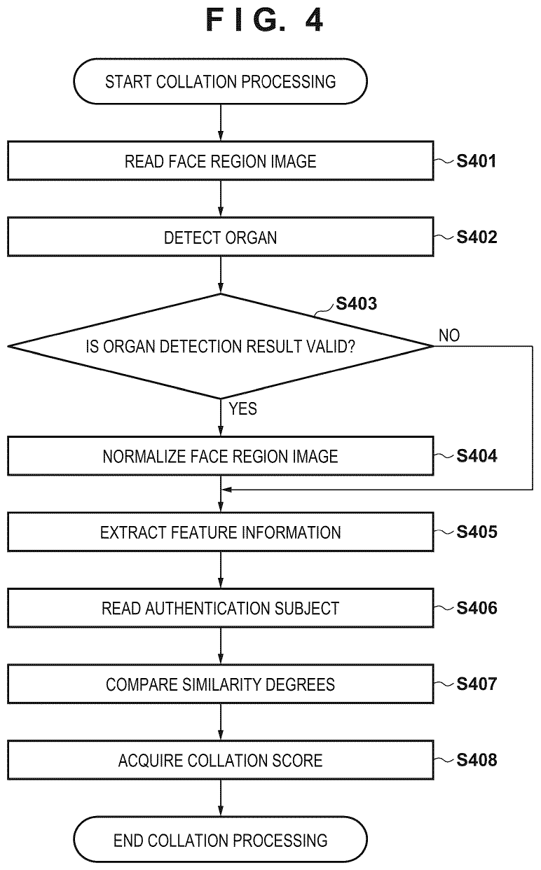

Next, the main object determination processing and the collation processing will be described in detail with reference to FIGS. 3 and 4. FIG. 3 is a flowchart for explaining control from image acquisition to main object determination, and FIG. 4 is a flowchart for explaining a collation processing in particular in more detail. The processing of these flowcharts is realized by the control unit 201 loading a control program stored in a ROM in the computation apparatus 102 into a RAM and executing the program.
In step S301, the control unit 201 acquires one frame of an image from the image capturing element 104 in a series of images to be processed. The acquired image is converted into a resolution and a file format suitable for the subsequent detection processing and collation processing.
In step S302, the control unit 201 inputs the image to be processed into the object detector 211 and acquires the detection results therefrom. The detection results are made up of coordinates of a detected object region and a score representing the reliability of an object thereof. The object region is rectangular, and coordinates thereof can be represented by a combination of center coordinates, a width, and a height, or upper left coordinates and lower right coordinates. Since there is a possibility that a detected object is erroneously detected, filtering is performed to take only detection results having a predetermined threshold value or higher, referring to the confidence level score. Each of the detected objects is assigned a unique object ID. Authentication information such as an authentication subject, an authentication score, and an authentication state and the like is managed for each object ID.

In this step, Multi Object Tracking (MOT) by associating an object detected in the preceding frame with an object detected in the current frame is further performed. That is, the detection results of both frames are compared, and an object ID is inherited from the preceding frame for the detection results in which the object regions are similar, treating the object as being the same. As a method of determining a similarity degree between object regions, for example, a method of computing an Intersection over Union (IoU) and determining that the objects are similar when the similarity degree is equal to or larger than a predetermined threshold value may be used.
In step S303, the control unit 201 determines whether or not an object is detected by referring to the detection results. When there is no object, the control unit 201 ends the processing because there is no main object. When there is an object, the control unit 201 advances the processing to step S304.
In step S304, the control unit 201 selects an object to be collated in the current frame from the detected object. Since the collation unit 215 in the present embodiment is capable of collating one object per frame, when there are a plurality of detected objects, it is necessary to select one of them. The method of selecting the collation subject may be an arbitrary method. For example, it may be a method in which a frame in which a collation subject was last selected is stored and the object for which the most time has elapsed is selected, a method in which an object closest to the center of an image is preferentially selected, or the like.
In step S305, the control unit 201 checks whether or not a collation subject is selected in step S304. The control unit 201 advances the processing to step S306 when a collation subject is selected, and advances the processing to step S315 when no collation subject is selected.
In step S306, the control unit 201 performs collation processing.

Here, the collation processing of step S306 will be described with reference to FIG. 4.
In step S401, the control unit 201 reads the face region image of the object selected in step S304. In the face region image, a trimming region is determined with reference to the coordinates of the detection result, and the trimming region is cut out from the image to be processed. The cut out image is subjected to preprocessing for subsequent processing, such as scaling to a predetermined resolution.
In step S402, the control unit 201 detects an organ such as an eye, a nose, or a mouth using a face region image that has been subjected to the pre-processing. The organ is detected as a point and an organ point score representing coordinates thereof and a confidence therefor are outputted.
In step S403, the control unit 201 determines whether the detected organ is valid or invalid by referring to the organ point score. The control unit 201 advances the processing to step S404 when the organ is valid, and advances the processing to step S405 when the organ is not valid.
In step S404, the control unit 201 normalizes the image using the acquired coordinates of the organ point. At the time of normalization, an affine transformation is performed so that each organ can be placed at a predetermined position.
In step S405, the control unit 201 computes feature information from the normalized face region image. Examples of the method for computing the feature information include a rule-based algorithm for obtaining feature information from coordinates of feature points of facial parts such as an eye, nose, or mouth, and an algorithm for inputting an image into a neural network and obtaining feature information as an output thereof. In the present embodiment, a face region image is inputted into a learned deep neural network (DNN), and feature information of an object is extracted.
In step S406, the control unit 201 reads the characteristic information of an authentication subject stored in the database 216. The authentication subject is an object registered in advance by the user; a face region image is acquired in the same manner as the collation subject, and the feature information is acquired by inputting the face region image into a DNN after pre-processing. Multiple authentication subjects can be registered, and in this step, all authentication subject feature information is read.
In step S407, the control unit 201 compares similarity degrees of feature information of all of the collation subjects acquired from the database 216 and the feature information of the authentication subject acquired in step S405. In the present embodiment, a cosine similarity is used to compare the similarity degree, and real numbers from −1 to +1 are outputted as similarity scores. The collation is performed at 1:N, and a similarity score with each of the N authentication subjects is computed for one collation subject.
In step S408, the control unit 201 searches for an authentication subject having the highest similarity score from the N similarity scores, and sets its score as the collation score. The collation score, the authentication subject corresponding to the collation score, and the organ detection result acquired in step S402 are outputted, and the collation processing series ends.

Returning to FIG. 3, in step S307, the control unit 201 determines whether or not the collation subject is appropriate. Here, the determination is performed using an organ detection result obtained as the result of the authentication processing in step S306. If one or several organ point scores of the detected organ points are low, it is conceivable that a part of the face is hidden by an occluding object or the like, or that the object is facing to the rear. For this reason, the respective organ point scores are checked, and if there is an organ point that falls below a predetermined threshold value, it is determined that the collation subject is not appropriate, and the control unit 201 advances the processing to step S308. The threshold value may be determined for each organ point, or may be determined for the sum or average of all organ point scores. If the score of one eye is high, the threshold value may be dynamically changed, for example, by relaxing the threshold value for the other eye, or the like.
In step S309, the control unit 201 confirms the past collation history from the authentication information of the object that is the collation subject, and confirms whether or not collation has been performed even once therefor. The control unit 201 advances the processing to step S310 if collation has not been performed even once and this time is the first collation, and advances the processing to step S311 if collation has been performed.
In step S311, the control unit 201 determines, from the authentication information of the object that is the collation subject, whether or not the collation score acquired in the current frame is lower than the authentication score which is an evaluation value indicating the degree to which the object matches the authentication subject (a magnitude relationship between the collation score and the authentication score). The control unit 201 advances the processing to step S312 when the collation score falls below the authentication score, and advances the processing to step S313 when the collation score is the authentication score or higher.
In step S312, the control unit 201 updates the authentication score by a first update method. In step S313, the control unit 201 updates the authentication score by a second update method. In step S308, the control unit 201 updates the authentication score by a third update method. In step S310, the control unit 201 updates the authentication score by a fourth update method. Details of the first to fourth authentication score update methods will be described later.
In step S314, the control unit 201 updates an authentication state of each object based on the updated authentication score. The authentication state is a flag indicating whether or not an object is a person registered in the database. If the authentication score of an object that is a collation subject is equal to or larger than the predetermined threshold value, an authentication success state is set, and if the authentication score is less than the predetermined threshold value, an authentication failure state is set. In addition, the authentication subject is also updated. However, a plurality of different objects are not allowed to enter the authentication success state for the same authentication subject. For this reason, when updating to the authentication success state, it is checked whether another object that is in the authentication success state exists for the same authentication subject, and when one exists, the one with the higher authentication score is updated to the authentication success state and the one with the lower authentication score is updated to the authentication failure state.
In step S315, the control unit 201 determines the main object using the main object determination unit 212 based on the updated authentication state. First, the number of objects in the authentication success state from among all objects is confirmed. When the number of objects in the authentication success state is one, that object is set as the main object. When there are a plurality of objects in the authentication success state, the object having the highest priority order of the authentication subject set (designated) in advance by the user is set as the main object.

Next, the first to fourth authentication score update methods will be described. In the first update method, the authentication score is updated according to an exponential moving average using the authentication score N(n−1) in a preceding frame of the object and the collation score S(n) acquired in the current frame.

Assuming that a smoothing coefficient is α, the authentication score N(n) of the current frame is obtained by N(n)=αS(n)+(1−α)N(n−1). Here, the smoothing coefficient α is a real number between 0 and 1. The first update method is employed when S(n)<N(n−1) or S(n)≤N(n−1) is satisfied. Accordingly, even when an extremely low collation score is instantaneously acquired, the authentication score drops gradually, so that it is possible to suppress rejection of the actual person due to an erroneous authentication failure state.

In the second update method, the authentication score is similarly updated by an exponential moving average. However, the smoothing coefficient is β, which is different from α, and the authentication score is updated according to N(n)−βS(n)+(1−β)N(n−1). In this case α<β. As a result, when the authentication score decreases, the change is gradual, while when the authentication score increases, the change is sharp, so that it is possible to quickly transition to the authentication success state.

As described in step S302, MOT is performed on objects across frames, but in a case where objects cross or are crowded, or the like, erroneous tracking occurs, and there are cases where an authentication success state is inherited by the wrong object, resulting in an erroneous inheritance state. By providing the second update method, it is possible to quickly return to the correct authentication state even in the case of an erroneous inheritance state. β may be set to 1, and in this case, the collation score is used as is as the authentication score.

In the third update method, the authentication score is updated without using the collation score, and the score is updated by subtraction or multiplication using a predetermined value γ. When subtracting is performed, the score is updated according to N(n)=N(n−1)−γ, using an arbitrary real number γ. When multiplication is performed, the score is updated according to N(n)=γN(n−1), using a real number γ between 0 and 1. In the following description, it is assumed that subtraction is performed.

The third update method is selected when the collation subject is not appropriate. At this time, since the collation score cannot be trusted, it is necessary to update the authentication score without using the collation score. It is appropriate to lower the authentication score when the collation score cannot be used, since the risk of erroneous tracking occurring in MOT increases as time elapses.

The fourth update method is a method in which the collation score is set as the authentication score as is and is expressed by N(n)=S(n). The fourth update method is selected when the collation subject is collated for the first time. In this case, N(n−1) is an undefined value, and therefore cannot be used. A new object that has entered the frame or the like corresponds to this, but in this case, it is possible to improve usability by immediately raising the authentication score and entering the authentication success state.

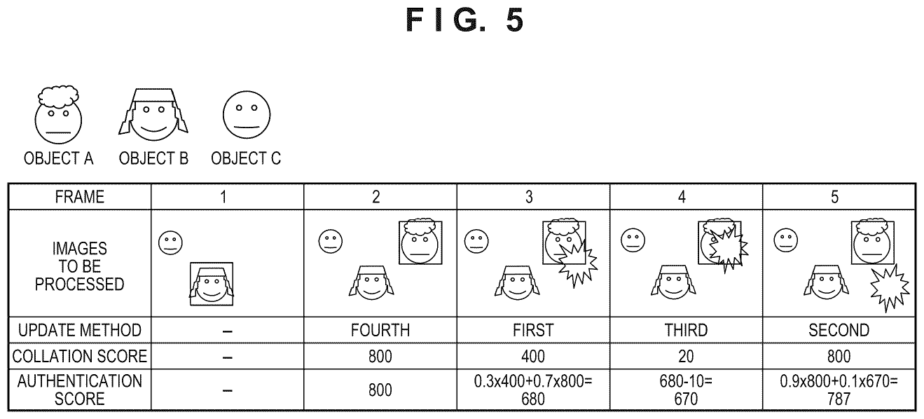

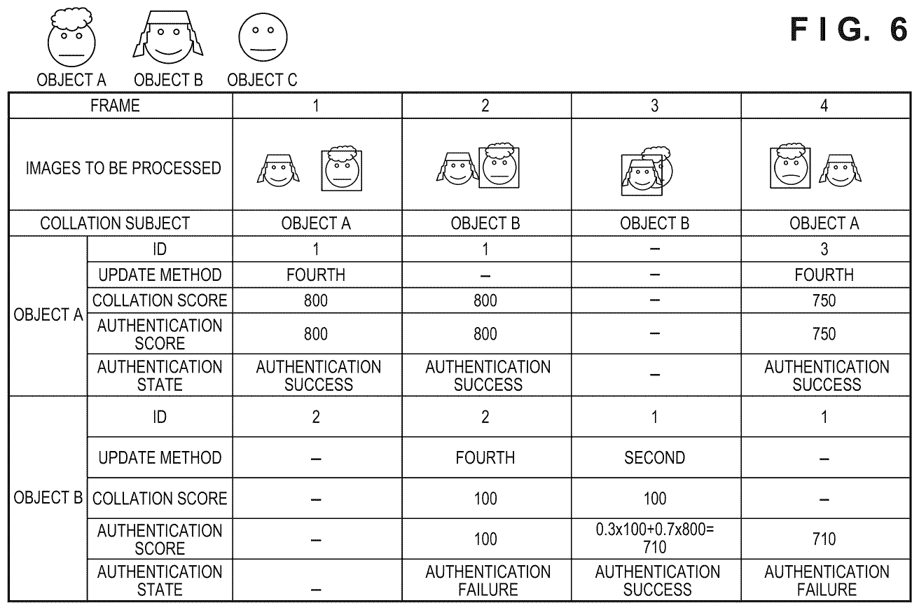

In view of the above, the change in the authentication score and the authentication state will be described using the specific examples illustrated in FIG. 5 and FIG. 6. The collation score and the authentication score are made to be integers between 0 and 1000, and the threshold of the authentication score is made to be 500. It is assumed that objects A to C appear and only the object A is registered in the database. The smoothing coefficient α of the first update method is 0.3, the smoothing coefficient β of the second update method is 0.9, and the predetermined value γ of the third update method is 10. In addition, a rectangular frame is given for the main object in each frame.

FIG. 5 is a view illustrating a specific example of a scene in which it is possible to suppress rejection of the actual person, which is an effect of the present embodiment. However, for the sake of clarity of explanation, it is assumed that frames where the collation subject is not the object A are omitted, and the object A is selected as the collation subject in all frames in which the object A is present.
In frame 1, no authentication subject exists in the processing subject image. In this case, since the main object is determined according to the composition and the size of the object, the object B is selected as the main object.
In frame 2, the object A enters the frame in the processing subject image, and is selected as the collation subject. As a result of the authentication process, 800 is acquired as the collation score. Since the object A is being collated for the first time, the fourth update method is selected, and the authentication score is 800, which is the same as the collation score. Since the authentication score of the object A exceeds the threshold value 500, the object A enters the authentication success state and becomes the main object.
In frame 3, since a part of the object A is hidden, the collation score decreases to 400. The first update method is selected because the collation score is below the authentication score 800 of the preceding frame. From the expression of the exponential moving average with the smoothing coefficient of 0.3, the authentication score drops to 680. Although the collation score is less than the threshold value 500, the authentication score is greater than the threshold value, so the authentication success state can be maintained, and the object continues to be the main object.
In frame 4, since the area of the object A that is hidden is even larger, the collation score decreases by 20. At this time, since the left eye is completely hidden, the organ point score drops below the threshold. As a result, it is determined that the collation subject is not appropriate, and the third update method is selected.

In this case, the authentication score is updated to 670 by subtracting the predetermined value 10 from the authentication score 680 of the preceding frame. If the first update method were selected for this frame, the authentication score would become 482 and fall below the threshold value, the authentication failure state would be entered, and the main object would be changed to the object B. In other words, since the third update method is selected, the object A can be kept in the authentication success state.
In frame 5, the object A ceases to be in the hidden state, and the collation score becomes 800 again. The second update method is selected because the collation score is above the authentication score 670 of the preceding frame. From the expression of the exponential moving average with the smoothing coefficient of 0.9, the authentication score rises to 787. Even if, hypothetically, the authentication score were less than the threshold in frame 3 or frame 4, since the smoothing coefficient is large, the authentication success state can be transitioned into in frame 5, and the object A can be made to be the main object again.

FIG. 6 is a view illustrating a specific example of a scene in which suppression of an erroneous inheritance, which is an effect of the present embodiment, is possible.
In frame 1, it is assumed that the object A being tracked is selected as the collation subject as ID: 1. In this frame, the authentication score of the object A is updated by the fourth update method, and the object A is in the authentication success state.
In frame 2, the collation subject is switched to the object B being tracked as ID: 2. Since the object B is not registered in the database and is compared with the feature information of the object A in the database, the collation score indicates a low value. The authentication score is updated by the fourth update method.
In frame 3, the object A and the object B cross each other. In this case, since only one object is detected, the object of either ID: 1 or ID: 2 disappears. Here, the main object in the preceding frame is prioritized and ID: 1 remains. Consequently, the object B is recognized as ID: 1 and erroneously tracked. The collation subject is the object B, and a low collation score is indicated as in the preceding frame. At this time, the authentication score is updated by the second update method. However, since erroneous tracking has occurred, the authentication score in the preceding frame inherits the score of the object A. As a result of the computation according to the exponential moving average, the authentication score is 710. Since the authentication score exceeds the threshold value 500, the authentication success state is entered and it becomes the main object. Since the object B is not actually a registered object, an erroneous inheritance state has been entered.
In frame 4, object A reappears and ID: 3 is allocated as a new object. In this frame, the object A is selected as the collation subject. The authentication score is updated by the fourth update method, and the authentication score becomes 750. Since this score exceeds the threshold value 500, it is possible to transition into the authentication success state. However, since the object B was also in the authentication success state in the preceding frame, one of them needs to be put into the authentication failure state. When the authentication scores of the respective objects are compared, since the authentication score of object A is higher, object A is put in the authentication success state and object B is put in the authentication failure state. Since the authentication score of the object in the erroneous inheritance state is lowered by the second update method in frame 3 and the collation score is accepted as the authentication score by the fourth update method as is in frame 4, when the correct authentication subject appears, the erroneous inheritance state can be corrected immediately.

In this example, since only the object A is registered in the database as the authentication subject, only one object is in the authentication success state, but when a plurality of people are registered in the database, there may be objects in the authentication success state for each of the registered authentication subjects. That is, in a case where N people are registered in the database, up to N objects may be in the authentication success state. In this case, the main object is determined in accordance with a priority order of the objects registered in the database, which is set by a user in advance.

As described above, in the present embodiment, in a face authentication system, one of a plurality of authentication score update methods is selected according to the situation, and the authentication score in the current frame is updated using the collation score and the authentication score in the preceding frame. As a result, it is possible to stably and sensitively transition into an authentication success state in response to a temporary decrease in the collation score due to a change in expression, occlusion, or the like, of an object and it is possible to achieve both suppression of erroneous inheritance and suppression of rejection of the actual person.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An authentication apparatus, comprising:
at least one processor or circuit and a memory storing instructions to cause the at least one processor or circuit to perform operations of the following units:
a detection unit configured to detect an object from an inputted image;
a collation unit configured to collate the object detected by the detection unit with an authentication subject registered in advance, and output a collation score indicating a similarity degree between the object and the authentication subject;
an update unit configured to, based on the collation score, update an authentication score, which is an evaluation value that indicates a degree to which the object matches the authentication subject; and
an authentication unit configured to authenticate the object based on the authentication score,
wherein the update unit changes a method of updating the authentication score based on a magnitude relationship between the collation score and the authentication score.

2. The authentication apparatus according to claim 1, wherein the detection unit detects an object from each of inputted continuous images.

3. The authentication apparatus according to claim 1, wherein the at least one processor or circuit is configured to further function as a selection unit configured to select a subject to collate with the authentication subject from objects detected by the detection unit.

4. The authentication apparatus according to claim 1, wherein the update unit, in a case where the collation score is smaller than the authentication score, updates the authentication score using a first update method, and in a case where the collation score is greater than or equal to the authentication score, updates the authentication score using a second update method.

5. The authentication apparatus according to claim 4, wherein the first update method and the second update method update the authentication score according to exponential moving averages with different smoothing coefficients.

6. The authentication apparatus according to claim 5, wherein the smoothing coefficient in the first update method is smaller than the smoothing coefficient in the second update method.

7. The authentication apparatus according to claim 1, wherein the update unit, in a case where a collation score of an object cannot be acquired, updates the authentication score using a third update method.

8. The authentication apparatus according to claim 7, wherein, in the third update method, the authentication score is updated by multiplying a predetermined coefficient with the authentication score.

9. The authentication apparatus according to claim 7, wherein, in the third update method, the authentication score is updated by subtracting a predetermined value from the authentication score.

10. The authentication apparatus according to claim 1, wherein the update unit, for an object for which collation with the authentication subject is performed for the first time, updates the authentication score by a fourth update method that sets the collation score as the authentication score.

11. An authentication method comprising:
detecting an object from an inputted image;
collating the detected object with an authentication subject registered in advance, and outputting a collation score indicating a similarity degree between the object and the authentication subject;
based on the collation score, updating an authentication score, which is an evaluation value that indicates a degree to which the object matches the authentication subject; and
authenticating the object based on the authentication score,
wherein, in the updating, a method of updating the authentication score is changed based on a magnitude relationship between the collation score and the authentication score.

12. An image capturing apparatus, comprising:
at least one processor or circuit and a memory storing instructions to cause the at least one processor or circuit to perform operations of the following units:
a detection unit configured to detect an object from a captured image;
a collation unit configured to collate the object detected by the detection unit with an authentication subject registered in advance, and output a collation score indicating a similarity degree between the object and the authentication subject;
an update unit configured to, based on the collation score, update an authentication score, which is an evaluation value that indicates a degree to which the object matches the authentication subject; and
a determination unit configured to determine a main object based on the authentication score,
wherein the update unit changes a method of updating the authentication score based on a magnitude relationship between the collation score and the authentication score.

13. The image capturing apparatus according to claim 12, wherein the detection unit detects an object from each of captured continuous images.

14. The image capturing apparatus according to claim 12, wherein the at least one processor or circuit is configured to further function as a selection unit configured to select a subject to collate with the authentication subject from objects detected by the detection unit.

15. The image capturing apparatus according to claim 12, wherein the update unit, in a case where the collation score is smaller than the authentication score, updates the authentication score using a first update method, and in a case where the collation score is greater than or equal to the authentication score, updates the authentication score using a second update method.

16. The image capturing apparatus according to claim 15, wherein the first update method and the second update method update the authentication score according to exponential moving averages with different smoothing coefficients.

17. The image capturing apparatus according to claim 16, wherein the smoothing coefficient in the first update method is smaller than the smoothing coefficient in the second update method.

18. The image capturing apparatus according to claim 12, wherein the update unit, in a case where a collation score of an object cannot be acquired, updates the authentication score using a third update method.

19. The image capturing apparatus according to claim 18, wherein, in the third update method, the authentication score is updated by multiplying a predetermined coefficient with the authentication score.

20. The image capturing apparatus according to claim 18, wherein, in the third update method, the authentication score is updated by subtracting a predetermined value from the authentication score.

21. The image capturing apparatus according to claim 12, wherein the update unit, for an object for which collation with the authentication subject is performed for the first time, updates the authentication score by a fourth update method that sets the collation score as the authentication score.

22. The image capturing apparatus according to claim 12, wherein the determination unit, in a case where a plurality of objects are authenticated as the same authentication subject, determines the object with the highest authentication score as the main object.

23. The image capturing apparatus according to claim 12, wherein the determination unit, in a case where a plurality of objects are authenticated as different authentication subjects, determines the object authenticated as an authentication subject with the highest user designated priority order as the main object.

24. The image capturing apparatus according to claim 12, wherein focusing control or exposure control is performed preferentially for the object determined as the main object by the determination unit.

25. A method of controlling an image capturing apparatus, the method comprising:
detecting an object from a captured image;
collating the detected object with an authentication subject registered in advance, and outputting a collation score indicating a similarity degree between the object and the authentication subject;
based on the collation score, updating an authentication score, which is an evaluation value that indicates a degree to which the object matches the authentication subject; and
determining a main object based on the authentication score,
wherein, in the updating, a method of updating the authentication score is changed based on a magnitude relationship between the collation score and the authentication score.

26. A non-transitory computer readable storage medium storing a program for causing a computer to execute each step of an authentication method, the method comprising:
detecting an object from an inputted image;
collating the detected object with an authentication subject registered in advance, and outputting a collation score indicating a similarity degree between the object and the authentication subject;
based on the collation score, updating an authentication score, which is an evaluation value that indicates a degree to which the object matches the authentication subject; and
authenticating the object based on the authentication score,
wherein, in the updating, a method of updating the authentication score is changed based on a magnitude relationship between the collation score and the authentication score.

27. A non-transitory computer readable storage medium storing a program for causing a computer to execute each step of a method of controlling an image capturing apparatus, the method comprising:
detecting an object from a captured image;
collating the detected object with an authentication subject registered in advance, and outputting a collation score indicating a similarity degree between the object and the authentication subject;
based on the collation score, updating an authentication score, which is an evaluation value that indicates a degree to which the object matches the authentication subject; and
determining a main object based on the authentication score,
wherein, in the updating, a method of updating the authentication score is changed based on a magnitude relationship between the collation score and the authentication score.
